(19) United States
(12) Patent Application Publication
(10) Pub. No.: US 2025/0174026 A1
(43) Pub. Date: May 29, 2025

(54) IMAGE PROCESSING ASSEMBLY, MONITORING SYSTEM, TRANSMISSION DEVICE, RECEIVING DEVICE AS WELL AS METHOD

(71) Applicant: Robert Bosch GmbH, Stuttgart (DE)

(72) Inventor: Moritz Michael Knorr, Hildesheim (DE)

(21) Appl. No.: 18/959,514

(22) Filed: Nov. 25, 2024

(30) Foreign Application Priority Data
Nov. 28, 2023 (DE) 10 2023 211 841.6

(51) Int. Cl. G06V 20/52; G06T 7/70; G06V 10/44; H04N 19/70

(52) U.S. Cl. CPC G06V 20/52; G06T 7/70; G06V 10/44; H04N 19/70; G06T 2207/20132; G06V 2201/07

(57) ABSTRACT

The invention relates to an image processing assembly 1 having a transmission device 2, comprising: a camera interface 5 for acquiring image data 9 from a camera 6; a video encoder 14 for encoding the image data 9 and generating encoded image data; a transmitting detector device 8 for detecting image features 10 with a first detection certainty in feature image areas 11 of the image data 9 and a cropping device 12 for cropping the feature image areas 11, wherein the image features 10 with the feature image areas 11 comprise content data, a content encoder 13 for encoding the content data and generating encoded content data, a transmission interface 6 for transmitting the encoded image data and the encoded content data; with a receiving device 3, comprising: a receiving interface 7 for receiving the encoded image data and the encoded content data; a video decoder device 15 for decoding the encoded image data and generating decoded image data; a content decoder device 16 for decoding the encoded content data and for generating decoded content data, and at least one receiving detector device 17 for detecting and/or verifying the image features with a second detection certainty based on the decoded content data.

### BACKGROUND

The invention relates to an image processing assembly. The invention also relates to a monitoring system, a transmission device, and a receiving device for the image processing assembly, as well as to a method for training the image processing assembly.

In principle, it is known that image processing algorithms are carried out on a capturing camera and the camera then directly outputs the results of the image processing. With the development of digital networks, it has also become established that the camera is only responsible for recording the video sequences and that an evaluation via image processing is carried out de-centrally, for example on a server or in the cloud.

Publication U.S. Pat. No. 10,373,300B1 discloses a system and method for lossy image and video compression and transmission that utilizes a neural network as a function to associate a known noise image with a desired or target image, thereby transmitting only hyperparameters of the function rather than a compressed version of the image. This allows for restoration of a high quality approximation of the desired image by any system that receives the hyperparameters, provided that the receiving system has the same noise image and a similar neural network.

### SUMMARY

The object of the invention is an image processing assembly which is in particular suitable and/or configured for a monitoring system. The image processing assembly is in particular configured as a digital image processing assembly.

The image processing assembly comprises a transmission device. The transmission device includes a camera interface for taking image data from a camera. Optionally, the transmission device comprises the camera. The camera is in particular designed as a monitoring camera. However, it may also be realized as a vehicle camera, in particular for automotive applications. It is also possible that the camera is realized as a satellite camera for observing the atmosphere. The camera interface is configured to accept image data from the camera. The image data may be realized as single images or as video sequences.

The transmission device comprises a video encoder device for encoding the image data and for generating encoded image data. In particular, the image data is compressed into encoded image data upon transfer such that a quantity of image data transmitted is reduced by encoding the image data.

The transmission device comprises a transmitting detector device for detecting image features having a first detection certainty in feature image areas of the image data. For example, the detection of the image features may be based on digital image processing. For example, as image features, detection objects are first segmented and subsequently detected, as is known from the prior art. The image features are arranged in feature image areas of the image data. The image features are thus shown in the feature image areas. If, for example, one of the detection objects is detected as an image feature, the detection object is shown in the feature image areas.

The transmitting detector device comprises a cropping device for cropping the feature image areas from the image data. The process of cutting out the feature image areas from the image data is also referred to as cropping. The image features with the associated feature image areas represent content data. The image features are associated with the feature image areas via data technology, for example, by a mapping function, table or rule, or the like.

The transmission device includes a content encoder device for encoding the content data and generating encoded content data. In particular, it is contemplated that the quantity of content data transmitted will be reduced by the process of encoding the content data. The feature image areas can be encoded together with the image features. Alternatively, the image features and feature image areas are encoded separately from one another, wherein, however, the image features are associated with the feature image areas.

The transmission device comprises a transmission interface for transmitting the encoded image data of the encoded content data. The transmission can be carried out via a network connection, for example, in particular via the Internet. Alternatively or in addition, the transmission can be carried out via alternative, in particular wireless network connections. In particular, the transmission is carried out in real time.

The image processing assembly comprises a receiving device. It includes a receiving interface for receiving the encoded image data and the encoded content data.

The receiving device comprises a video decoder device for decoding the encoded image data to generate decoded image data. The decoded image data may, for example, be stored in a logging device as an optional component of the image processing assembly for logging purposes or may be viewed on a display device as an optional component of the image processing assembly by monitoring personnel.

The receiving device includes a content decoder device for decoding the encoded content data, such that the decoded feature image areas for the decoded image features associated with the decoded feature image areas are available.

The receiving device comprises at least one receiving detector device for detecting and/or verifying the image features with a second detection certainty based on the decoded content data.

In particular, it is contemplated that the second detection certainty is higher than the first detection certainty. A detection certainty, e.g., formed as significance, is understood to mean a measure of the probability that the respective image feature is present in the image data. The false-positive rate during detection of image features, for example, is higher with the first detection safety than with the second detection certainty. Thus, a higher rate of false-positive detections of image features is deliberately generated with the first detection certainty in the transmission device, wherein the rate of false-positive detections of image features is reduced by the receiving device. Alternatively or in addition, the detection probability is comprised as, or is comprised by, an “accuracy”, a “confidence” and/or a “precision”.

It is, therefore, a consideration of the invention that the requirements for the detection quality of modern cameras are constantly increasing. To further increase these, higher-performing computer chips may be used to allow higher detection power or larger neural networks to operate on the camera, or the video data may be transmitted directly to the cloud (or another client) where higher-performing hardware may be used. During the transmission, it is assumed that not only the detections themselves (detection objects, e.g. vehicles, people, . . . ) are of interest, but also the video stream, i.e. the image data. The drawback of the two options is that either a powerful computer chip must be used on the camera itself or a video stream in high (sufficient) quality must be transmitted.

Enabling hybrid processing is proposed according to the present invention. In this case, the video stream, i.e. the image data, is in particular highly compressed, since it is primarily only used for visual control (understanding the scene for an operator), and at the same time the detection is not carried out entirely on the camera side. Instead, the information necessary for detection is encoded on the client side (e.g., by an auto-encoder) and is also transmitted. The actual detection and/or verification then takes place on the client side. The information is decoded and optionally combined with the previously highly compressed image data. Image processing, particularly through a neural network that is less hardware constrained on the client side, then performs the actual detection or verification.

Thus, a hybrid method is proposed in which, in addition to the (highly) compressed and encoded video signal of the image data, a data stream generated as an encoder via the content encoder device is transmitted. On the receiver side, this data stream is then optionally combined with the decoded compressed video signal and supplied to a decoder and/or detector network. Detections (or potential detections) are first generated by a detector of the transmitting detector device on the camera side. Thereafter, the corresponding image content is cropped as feature image areas and individually fed to one or more encoders of the content encoder device. The resulting data stream is then also transmitted to the client side with the receiver device, where one or more decoders and/or detectors are used to generate or verify detections. Preferably, it is contemplated that the size and/or quantity of data transmitted, encoded, and compressed in the video stream of the image data, along with the encoded (and compressed) additional data stream of the content data, is less than the size of a video stream of the image data with a higher quality/resolution. For example, an original image of the image data may be reduced from eight megapixels to below one megapixel, thereby, and by decreasing image quality, reducing the file size by a factor of 200.

The advantage is thus that the video stream of the image data itself can be highly compressed (because it is not or not the only basis for detection on the client side) and that the camera does not have to have a correspondingly high processing power, in particular a large/complex neural network, because a “poor detector”, e.g. with a high false-positive rate, can be used in the transmission device. On the client side, higher computational powers, in particular more powerful accelerators for larger neural networks, may then be used to reduce the false positive rate to improve detection certainty.

In addition, the exact point of operation (ratio of true to false (false positive) or missed detections) on the client side can be adjusted as this does not have to be carried out already on the camera. Furthermore, an upgrade of the client-side hardware is typically easier, even more so if it is a cloud infrastructure. The availability of the content data as additional data also makes it possible to store the data for later analysis with a higher computational power, in particular a potentially better neural network.

In a preferred further development of the invention, the transmission device is configured to transfer the feature image areas in a time range in which the image features are active. Active image features include, in particular, image features for which detection of the image feature is present. For example, in the event that the image features are comprised as detection objects, the detection objects are present in the feature image areas when the image features are active. This further development has the advantage that feature image areas are only transmitted during the time when they are relevant to the image features; otherwise the transmission can be reduced or stopped fully. This further development helps to reduce the quantity of data transmitted between the transmission device and the receiving device.

In a further development or alternative of the invention, the feature image areas are configured as cropped sections of the image data. In particular, the feature image areas are true cropped images of the image data and thus smaller than the image data. For example, the feature image areas occupy less than 50%, particularly less than 30% of the image area of the image data. In this way, the quantity of data transmitted between the transmission device and the receiving device is further decreased.

It is preferable that the feature image areas are transmitted between the transmission device and the receiving device at a higher resolution than the image data. Alternatively, or in addition, for the purpose of transmission, the image data is compressed more than the feature image areas. This preferred embodiment is based on the consideration that the image data is usually only used for visual, in particular human control, or for logging purposes. In this case, it is only necessary to transmit the content in a visible and/or recognizable manner; a particularly high resolution is not necessary. However, the detection and/or verification of the image features by the receiving detector device is to be carried out from the feature image areas, so that higher resolution and/or lower compression leads to an improvement in the detection performance and/or verification performance of the image features.

In a preferred application, the transmitting detector device is configured to detect detection objects, such as stationary, quasi-stationary, or moving detection objects, as the image features in the image data. In particular, the image features comprise descriptions or other information of the detected detection objects. In particular, the image features are realized as metadata. The feature image areas comprise a position of the detection objects, in particular the feature image areas show the detected detection objects. In this way, the quantity of data transmitted for the feature image areas is reduced to the size required for evaluation by the receiving detector device.

It is preferred that the video encoder device and/or the content encoder device operate on the basis of an H.26 encoder, in particular on the basis of an H.264/MPEG-4 AVC encoder. In particular, the image data and/or feature image areas may be transmitted as MP3 or MP4 data. This technology is very reliable and easy to implement.

In a preferred further development of the invention, the receiving device comprises a receiving detector network, wherein the receiving detector network comprises the receiving detector device. The reception detector network is configured to carry out the detection/or verification of the image features based on the decoded content data and the decoded image data. In this way, the information basis for the detection and/or verification of the image features is increased so that better results are expected with the same quantity of transmitted data. It is also possible that different neural networks may be provided in the receiver detector network for detection and/or verification of the image features.

Particularly preferably, the video encoder device and/or the content encoder device are respectively configured as an autoencoder, where appropriate. The property of the autoencoder is to teach a compressed representation (encoding) for the image data, or feature data areas and extract the essential features to thereby reduce the quantity of data transmitted.

A further subject matter of the invention relates to a monitoring system comprising the image processing assembly as previously described. The monitoring system may be configured as a stationary monitoring system, a monitoring system for autonomous driving in automotive applications, etc.

A further subject matter of the invention relates to the transmission device which is suitable and/or configured for the image processing assembly, as described above.

A further subject matter of the invention relates to the receiving device which is suitable and/or configured for the image processing assembly as described above.

A further subject matter of the invention relates to a method for training the image processing assembly, as described above and/or the monitoring system as described above, wherein the image processing assembly is trained end-to-end with training data comprising image data and image features, wherein one training target and/or a hyperparameter is the reduction/minimization of the quantity of encoded content data transmitted and optionally, in addition, the encoded image data.

Another optional subject matter relates to a method of operating the image processing assembly and/or the monitoring system as described above. Another optional subject matter relates to a computer program configured to implement the method when executed on the image processing assembly and/or on the monitoring system and/or on any digital data processing assembly. A further subject matter of the invention relates to a digital storage medium for storing the computer program.

### BRIEF DESCRIPTION OF THE DRAWINGS

Further features, advantages and effects of the invention are shown in the following description of a preferred exemplary embodiment of the invention and in the accompanying figures. Shown are:

FIG. 1 a schematic block diagram of an image processing assembly as an exemplary embodiment of the invention.

### DETAILED DESCRIPTION

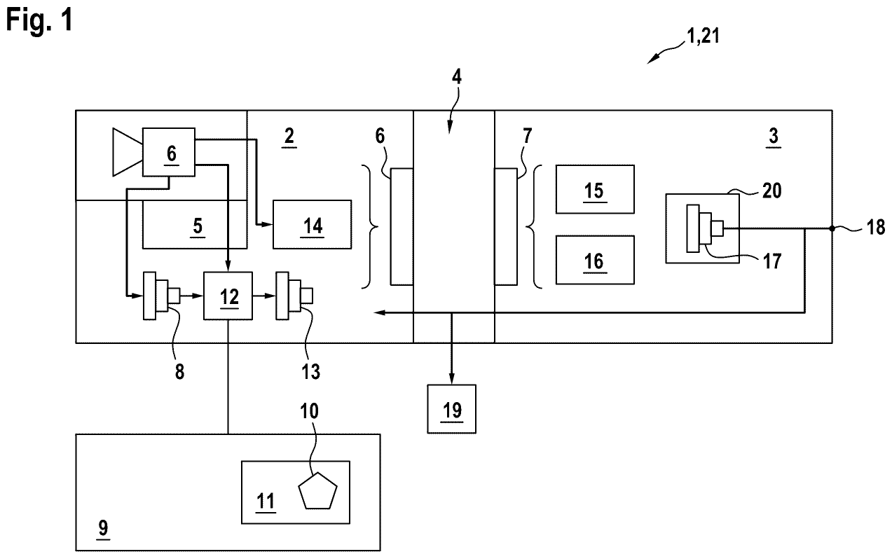

FIG. 1 shows a schematic block diagram of an image processing assembly 1 as an exemplary embodiment of the invention.

The image processing assembly 1 comprises a transmission device 2 as well as a receiving device 3. The receiving device 3 serves as a client for the transmission device 2. The transmission device 2 and the receiving device 3 are connected to one another via a network connection 4. For example, the network connection 4 may be configured as an internet connection or as a connection in a mobile network. The transmission device 2 comprises a transmission interface 6 for communication with the receiving device 3, which comprises a receiving interface 7.

The transmission device 2 comprises a camera interface 5 for connection to a camera 6. The camera 6 may also be configured to include a component of the image processing assembly 1, in particular the transmission device 2.

The transmission device 2 comprises a transmitting detector device 8, which is configured to examine via digital image processing in image data 9 generated by the camera 6 and/or transferred to the transmission device 2 and/or to the transmission detector device 8 via the camera interface 5.

The transmission detector device 8 is configured to detect image features 10 in the image data 9 with a first detection certainty. The image features 10 are arranged and/or detected and/or detectable in feature image areas 11 in the image data 9. The image features 10 are configured as metadata, for example, in particular data sets associated with the respective image feature 10. The image features 10, in particular the metadata, in particular comprise an image location of the image feature 10 in the image data 9.

The image features 10, in particular the metadata, are transferred to a cropping device 12. Further, the image data 9 is transferred at least in excerpts to the cropping device 12. The image data 9 can be transferred from the transmission detector device 8 or from the camera interface 5 to the cut-out device 12.

The cropping device 12 is configured to crop the feature image areas 11 from the image data 9 so that the feature image areas 11 are configured as cropped images of the image data 9. Optionally, the feature image areas 11 are cropped only in a time range in which the associated image feature 10 is active, i.e., when the associated image feature 10 is detected.

The image features 10 with the associated feature image areas 11 comprise content data, wherein the content data is supplied to a content encoder 13. The content encoder 13 is configured to encode the content data to generate encoded content data in this manner. The encoded image features 10 and the encoded feature image areas 11 may be encoded separately or together. The encoded content data is supplied to the transmission interface 6.

The transmission device 2 comprises a video encoder device 14, which encodes the image data 9 and generates encoded image data. The encoded image data is supplied to the transmission interface 6. The transmission interface 6 is configured to provide and/or transmit the encoded image data and the encoded content data to the receiving device 3.

The receiving device 3 receives the encoded image data and the encoded content data via the receiving interface 7. The receiving device 3 comprises video decoder device 15 for decoding the encoded image data and for providing decoded image data. The decoded image data may be provided to a central monitoring unit (not shown), in particular a display screen device to be displayed, and/or stored in a logging device (not shown).

The receiving device 3 comprises a content decoder device 16 for decoding the encoded content data and for providing decoded content data.

The receiving device 3 includes a receiving detector device 17 for detecting and/or verifying image features 10 having a second detection certainty based on the decoded content data, in particular the decoded image features 10 and the decoded associated feature areas 11. The second detection certainty is configured to be higher than the first detection certainty.

The detected image features 10 can be output via an output interface 18 or can be transmitted to the transmission device 2 or to a controller 19 via the network device 4. The detected image features 10 may be displayed or used for monitoring and/or control purposes.

The structure of the image processing assembly 1 is designed so that the amount of data transmitted via the network connection 4 is kept low:

Thus, it is contemplated that the encoding of the image data 9 by the video encoder device 14 is more compressed as compared to the encoding of the feature image areas 11 by the content encoder device 13, since the decoded image data is only used to view the monitoring scene in one possible embodiment, so that a high image quality is not required. Increasing compression during transmission reduces the amount of transmitted data.

The feature image areas 11, on the other hand, are transmitted in a less compressed manner, so that the image quality is better, especially when compared to the image data 9. This procedure still allows for the amount of data transmitted to be kept low, because the feature image areas 11 only comprise cropped areas of the image data 9 and thus the image size is smaller for the feature image areas 11 than for the image data 9. Further, only feature image areas 11 are transmitted for detected and/or active image features 10, such that feature image areas 11 are only transmitted temporarily.

The feature image areas 11 are selected via the transmission detector device 8, which carries out detection in the image data 9 according to the image features 10. This is carried out with a first detection certainty, which is less than the second detection certainty at the receiving detector device 17. More false-positive image features 10 are in particular detected with the first detection certainty as compared to the second detection certainty. By allowing for poorer detection capability in the transmitting detector device 8, it can operate at a lower computational power and/or complexity, requiring less hardware on the side of the transmission device 2. The correction of the detections is performed by the detection and/or verification of the image features 10 by the receiving detector device 17.

In an alternative embodiment, the receiving detector device 17 may also be a component of a receiving detector network 20, wherein the receiving detector network 20 carries out the detection and/or verification in addition based on the decoded image data.

The transmission encoder device 13 may be configured as an auto-encoder, which is configured to be capable of learning and/or to be trained in order to encode the content data with the smallest quantity of data transmitted as possible and thus to transmit it via network connection 4.

The transmitting detector device 8, receiving detector device 17, and/or receiving detector network 20 may each be configured as one or more neural networks. Alternatively, these are based on digital image processing.

The image processing assembly 1 may form or be part of a monitoring system 21, such as those used in stationary monitoring tasks, to monitor monitoring areas with a plurality of cameras 6. Alternatively, the monitoring system 21 may be configured for a vehicle, wherein the transmission device 2 is arranged in the vehicle and the receiving device 3 is realized, for example, in the cloud. In this embodiment, the image features 10 can be transmitted to the control device 19 as part of the vehicle in order to carry out monitoring tasks, in particular for driver assistance systems and/or for autonomous driving. The image features 10 may be configured as persons, other vehicles, stationary objects, etc., depending on the monitoring task.

Training of the image processing assembly 1 can be end-to-end, wherein image data 9 and associated known image features 10 can be used as the training data. The image data 9 can be uploaded via the camera interface 5, the detected image features 10 are output via the output interface 18, wherein the output detected image features 10 can be compared to the known image features 10 to train the image processing assembly 1. That is, the encoder(s) and decoder/detector (depending on the variant) are trained together. This could be the case, for example, with the cost function and data. The target bit rate of the video data stream as well as the additional data stream are input as hyper parameters.

The compression and encoding of the video signal may be carried out by methods such as H.264/AVC, as these are common methods and need not be newly developed, and since specific accelerators are often already in place. The proposed method may also be used for other tasks, such as semantic segmentation, calibration, or the like.

1. An image processing assembly (1)
having a transmission device (2) comprising:
a camera interface (5) for accepting image data (9) from a camera (6);
a video encoder device (14) for encoding the image data (9) and for generating encoded image data;
a transmitting detector device (8) for detecting image features (10) having a first detection certainty in feature image areas (11) of the image data (9) and a cut-out device (12) for cutting out the feature image areas (11), wherein the image features (10) comprise content data with the feature image areas (11),
a content encoder device (13) for encoding the content data and generating encoded content data,
a transmission interface (6) for transmitting the encoded image data and the encoded content data;
having a receiving device (3) comprising:
a receiving interface (7) for receiving the encoded image data and the encoded content data;
a video decoder device (15) for decoding the encoded image data and generating decoded image data;
a content decoder device (16) for decoding the encoded content data and generating decoded content data, and
at least one receiving detector device (17) for detecting and/or verifying the image features with a second detection certainty based on the decoded content data.

2. The image processing assembly (1) according to claim 1, wherein the transmission device (2) is configured to transfer the feature image areas (11) from a time range in which the image features (10) are active.

3. The image processing assembly (1) according to claim 1, wherein the feature image areas (10) are configured as cropped images of the image data (9).

4. The image processing assembly (1) according to claim 1, wherein the feature image areas (10) are transmitted at a higher resolution than the image data (9), and/or that the image data (9) is compressed more than the feature image areas (10).

5. The image processing assembly (1) according to claim 1, wherein the transmitting detector device (8) is configured to detect detection objects as the image features (10) in the image data (9), wherein the feature image areas (11) comprise a position of the detection objects.

6. The image processing assembly (1) according to claim 1, wherein the video encoder device (14) and/or the content encoder device (13) operate on the basis of an H.26x encoder.

7. The image processing assembly (1) according to claim 1, wherein the receiving device (3) comprises a receiving detector network (20), wherein the receiving detector network (20) comprises the receiving detector device (17), wherein the receiving detector network (20) is configured to carry out the detection and/or verification of the image features (10) based on the decoded content data and the decoded image data.

8. The image processing assembly (1) according to claim 1, wherein the video encoder device (14) and/or the content encoder device (13) are configured as an autoencoder.

9. The image processing assembly (1) according to claim 1, wherein the transmitting detector device (8), receiving detector device (17) and/or the receiving detector network (20) is configured as or comprises a neural network.

10. A monitoring system (21) with the image processing assembly (1) according to claim 1, wherein the monitoring system (21) is configured for stationary monitoring of monitoring areas and/or monitoring in a vehicle.

11. A transmission device (2) for the image processing assembly (1) according to claim 1, the transmission device comprising:
the camera interface (5) for accepting image data (9) from the camera (6);
the video encoder device (14) for encoding the image data (9) and for generating encoded image data;
the transmitting detection device (8) for detecting image features (10) in feature image areas (11) of the image data (9) and a cropping device (12) for cropping the feature image areas (11), wherein the image features (10) comprise content data with the feature image areas (11),
the content encoder (13) for encoding the content data and generating encoded content data, and
the transmission interface (6) for transmitting the encoded image data and the encoded content data.

12. A receiving device (3) for the image processing assembly (1) according to claim 1, the receiving device comprising:
the receiving interface (7) for receiving the encoded image data and the encoded content data, wherein the image features (10) having the feature image areas (11) comprise the content data,
the video decoder device (15) for decoding the encoded image data;
the content decoder device (16) for decoding the encoded content data, and
the at least one receiving detector device (17) for detecting image features (10) based on the decoded content data.

13. A method for training the image processing assembly (1) according to claim 1, wherein the image processing assembly (1) is trained end-to-end with training data comprising image data (9) and image features (11), wherein one training target is to reduce/minimize the quantity of encoded content data transmitted and optionally also reduce/minimize the quantity of encoded image data transmitted.
